(19) United States
(12) Patent Application Publication
(10) Pub. No.: US 2018/0282609 A1
(43) Pub. Date: Oct. 4, 2018

(54) Titanium Chloride Encapsulation for Acid Generation

(71) Applicant: THE UNIVERSITY OF NORTH CAROLINA AT CHAPEL HILL, Chapel Hill, NC (US)

(72) Inventors: Sergei Sheiko, Chapel Hill, NC (US); Mohammad Vatakhah-Varnosfaderani, Chapel Hill, NC (US)

(73) Assignee: THE UNIVERSITY OF NORTH CAROLINA AT CHAPEL HILL, Chapel Hill, NC (US)

(21) Appl. No.: 15/939,140

(22) Filed: Mar. 28, 2018

Related U.S. Application Data
(60) Provisional application No. 62/478,683, filed on Mar. 30, 2017.

(51) Int. Cl. C09K 8/536; C09K 8/528

(52) U.S. Cl. CPC C09K 8/536; C09K 8/528

(57) ABSTRACT

Capsules contain titanium chloride within an interior of the capsule, which are configured as hydrochloric acid generators upon exposure to a medium contained within an environment at the subterranean location, such as water molecules. The capsules may be configured to be inert in the ambient atmosphere, and are only activated in the presence of water to generate hydrochloric acid inside the capsules followed by a release of the acid to the surrounding environment. Such capsules can be delivered to a subterranean location for removal of filter cake or scale.

This application claims priority to U.S. Provisional Patent Application Ser. No. 62/478,683, which is hereby incorporated by reference herein.

### TECHNICAL FIELD

The present disclosure relates in general to enhanced oil recovery, and in particular to, an in situ generation of an acid in a subsurface or subterranean location.

### BACKGROUND INFORMATION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Currently, an acidizing operation within a wellbore is one of the most effective techniques for stimulation of oil or gas wells. Acidizing may be performed in new wells to maximize their initial productivity, and also may be performed in aging wells to achieve an original productivity of the wells. Particularly, hydrochloric acid (“HCl”) and hydrofluoric acid (“HF”) are desirable for carbonate and sandstone formations, respectively. However, strong acids such as these are very corrosive, and may cause irreparable damage to either or both the wellbore casing and the subterranean formation. Direct addition of such acids from a surface source into the formation may also be harmful to the environment and potentially unsafe.

In many damaged wellbores, operators are using mineral acids (e.g., HCl, HF) and/or organic acids (e.g., acetic, formic) for cleaning of scale in the borehole casing, remediation to remove filter cake in the wellbore, and formation damage treatments.

Filter cake is a residue deposited on a permeable medium (e.g., a subsurface rock formation) when a slurry, such as a drilling fluid, is forced under pressure against the medium. Filtrate is the liquid that passes through the medium, leaving the cake on the medium. Cake properties such as cake thickness, toughness, slickness, and permeability are important because the cake that forms on permeable zones in the wellbore can cause stuck pipe and other drilling problems. Reduced oil and gas production can result from reservoir damage when a poor filter cake allows deep filtrate invasion. Typically, the primary drilling mud includes materials such as bentonite clays, barite, polymers, such as xanthan gum, starch, and the like. These primary drilling fluids produce filter cakes, which function to reduce fluid loss from the wellbore during drilling. Additionally, the primary drilling mud and a drill-in-fluid (“DIF”) create filter cakes on the inside of the wellbore as filtrate from the drilling mud or the drill-in-fluid escape into the formation through the inside diameter of the wellbore. This filter cake, once formed, also restricts fluid flow from the formation during production.

The combination of high reservoir temperature and long shut-in times after acid treatment lead to a high probability of severe corrosion of the well completion. In addition to the corrosion concerns with common acids, the rapid removal of the filter cake with strong acids could create localized, high leak-off of the treating fluid resulting in an uneven distribution of acid across a horizontal open-hole section.

Historically, acid, particularly HCl has been used to treat drilling fluid damage. Acid treatments are suitable where the well has been drilled with a DIF containing an acid-soluble material such as calcium carbonate or has been drilled into a carbonate formation so the DIF contains carbonate formation fines. HCl acidizing can give good results in wells with short production intervals. When used to treat longer producing intervals, HCl is typically used in conjunction with various diversion techniques or coiled tubing (“CT”). However, the very fast reaction rate of HCl can significantly limit the zonal coverage achieved by HCl treatments, even when placed by CT. When using HCl, it is difficult to achieve uniform damage removal over long openhole horizontal producing intervals, which can result in disappointing well productivity. Moreover, if the wellbore is near water bearing zones, there is a significant risk that using HCl may “wormhole” through to water bearing zones and significantly increase water production. Field experience has established and laboratory experiments have supported that rapid reacting acids, and particularly HCl, may be unable to provide uniform filter cake removal. In addition to its undesirable fast reaction rate, use of HCl poses significant health and safety risks as well as corrosion and environmental concerns. The oil and gas industry has recognized that a more uniform placement of acid can be achieved if the reaction of the acid is “retarded” in some way.

Wells producing water are likely to develop deposits of inorganic scales. Scales can and do coat perforations, casing, production tubulars, valves, pumps, and downhole completion equipment, such as safety equipment and gas lift mandrels. If allowed to proceed, this scaling will limit production, eventually requiring abandonment of the well. As brine, oil, and/or gas proceed from the formation to the surface, pressure and temperature change and certain dissolved salts can precipitate. This is called “self-scaling.” If a brine is injected into the formation to maintain pressure and sweep the oil to the producing wells, there will eventually be a commingling with the water present in the subterranean formation. Additional salts may precipitate in the formation or in the wellbore (scale from “incompatible waters”). Many of these scaling processes can and do occur simultaneously. Scales tend to be mixtures. For example, strontium sulfate is frequently found precipitated together with barium sulfate. The chemical formulae and mineral names for most oilfield scales include, but are not limited to calcite (CaCO₃), barite, celestite, anhydrite, gypsum, iron sulfide, and halite. Calcite deposition is generally a self-scaling process. The main driver for its formation is the loss of CO₂ from the water to the hydrocarbon phase(s) as pressure falls. This removes carbonic acid from the water phase, which had kept the basic calcite dissolved. Calcite solubility also decreases with decreasing temperature (at constant CO₂ partial pressure). “Exotic” scales such as calcium fluorite, zinc sulfide, and lead sulfide are sometimes found with high temperature/high pressure wells.

Scale remediation and prevention comes at a cost. It is more appropriate to think of scale control not as a cost, but in terms of “value added”—obviating the consequences of not remediating or preventing scale formation, and so increasing the total revenue from a well, as well as possibly extending its lifetime. The effects of scale can be quite expensive and rapid. For example, in one North Sea well, production fell from 30,000 barrels per day to zero in just 24 hours because of scaling. The cost for cleaning out the single well and putting it back on production was approximately the same as the chemical costs to treat the entire field. The cost savings because of less deferred/lost oil can result in substantially increased revenue over the life of the well, as well as more oil. It is anticipated that oilfield scaling problems will continue to worsen and become more expensive.

Scale remediation techniques must be quick and nondamaging to the wellbore, tubing, and the reservoir (e.g., the rock formation). The scale can be removed mechanically or dissolved chemically. Selecting the best scale-removal technique for a particular well depends on knowing the type and quantity of scale, its physical composition, and its texture. Operators commonly select an acid formulation based on the type of damaged components existing within the wellbore.

As a result of the foregoing, protected, targeted, and rate-controllable acid-release systems are desired to enable a more precise placement of the treatment at desired locations along the length of the wellbore and/or the rock formation being treated.

### BRIEF DESCRIPTION OF THE DRAWINGS

FIG. 1 illustrates processes for encapsulation of titanium chloride for subsequent conversion into HCl using loading of TiClₓ into polymeric capsules.

FIG. 2 illustrates an emulsion approach configured in accordance with embodiments of the present disclosure.

FIGS. 3A, 3B, 3C, 3D, 3E and 3F illustrate utilization of encapsulated titanium chloride (“TiClₓ”) for scale or filter cake removal, in accordance with embodiments of the present disclosure.

FIGS. 4A-4B illustrate generation of HCl in accordance with embodiments of the present disclosure.

FIGS. 4C-4D illustrate dissolution of CaCO₃ in accordance with embodiments of the present disclosure.

FIG. 5 illustrates delivery of embodiments of the present disclosure into a wellbore and/or subterranean formation.

### DETAILED DESCRIPTION

Aspects of the present disclosure generate an acid (e.g., HCl gas) on-demand within a subterranean location (e.g., an oil/gas reservoir), including within the wellbore and/or the rock formation. Aspects of the present disclosure provide polymeric capsules to encapsulate either TiCl₃ (solid) or TiCl₄ (liquid) within an interior of the capsule, which are configured as HCl generators upon exposure to a medium contained within an environment at the subterranean location (e.g., water molecules). Unlike previous technologies for acid delivery to a subterranean location, aspects of the present disclosure are based on in situ acid generation after subterranean deployment (e.g., within the wellbore and/or the rock formation). A unique feature of these materials is that they are configured to generate a greater (e.g., two times greater) amount of HCl than the most concentrated 37 wt % HCl solution possible (since the maximum solubility of HCL in water is 37%). These materials, which may be configured as capsules, are configured to be inert in the ambient atmosphere, and are only activated in the presence of water to generate HCl acid inside the capsules followed by a release of the acid to the surrounding environment through the following chemical reaction (also referred to herein as Equation (1)):

TiClₓ+H₂O→Ti(OH)ₓ+XHCl.

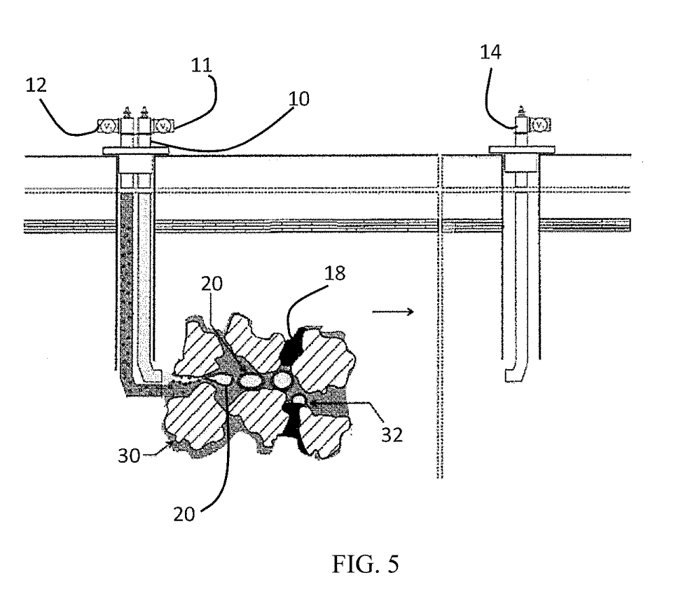

In other words, the capsules may be configured so that the acid is only generated inside of the capsules after they have been exposed to water molecules (e.g., at a subterranean location), and then the acid is released from the capsules. The rate of acid release may be controlled (e.g., may be retarded) by the rate of diffusion of water through the capsule shell and/or by the rate of diffusion of the generated HCl from inside to outside of the capsule (e.g., as the HCL disintegrates a portion of the capsule shell, or the utilization of a polymer material for the shell that permits a diffusion of the acid through the shell). In this respect, note that titanium hydroxide—a byproduct of the reaction between water and TiClₓ—is not soluble in water, and will remain inside the capsule's shell material, which can provide an additional mechanism for controlling the release rate of the generated acid (as it will retard the degradation the shell material by the HCL). However, the titanium hydroxide byproduct can also assist in the dispersion of the capsules in a brine solution, which can facilitate removal of the capsules after acid production at the subterranean location (e.g., see the discussion with respect to FIG. 5).

In accordance with embodiments of the present disclosure, the release rate can be enhanced (e.g., increased) by application of external stimuli to the capsules, such as heat and/or mechanical deformation (e.g., caused by a fracturing operation). The heat stimulation may involve a melting/glass transition of the capsule shell material, which may depend upon its chemical composition, which can be adjusted for a specific reservoir condition.

For additional control of the diffusion rate of water to the inside of the capsule and, correspondingly, the diffusion rate of the generated acid from the capsule core through the capsule shell and into the surrounding medium, another layer of the same or a different material may be deposited on the surface (i.e., a second shell) of the capsule.

Advantages of aspects of the present disclosure over existing technologies include that (1) it allows an in situ generation of HCl in subterranean systems (e.g., wellbore, rock formation, fractures) and consequently less corrosion on oil/gas exploration and extraction devices, (2) it has a higher efficiency due to generation of a pure acid from the capsules (see Equation (1)) compared to a maximum obtainable 37 wt % HCl solution that could be delivered to the subterranean location from the surface, (3) it results in less foreign material being loaded into the oil/gas field due to the larger amount of generated acid and the small sizes of the capsules (e.g., <1 micron), (4) it results in a triggered and/or enhanced (e.g., on-demand) generation of acid by external stimulation only after deliver to the desired location, (5) it has a lower (e.g., retarded) release rate due to consecutively implemented processes of water permeation, reaction, and acid release, and (6) additional control (e.g., decrease) of the release rate may be provided by the production of the titanium hydroxide (byproduct) inside of the capsules.

Preparation Methodologies

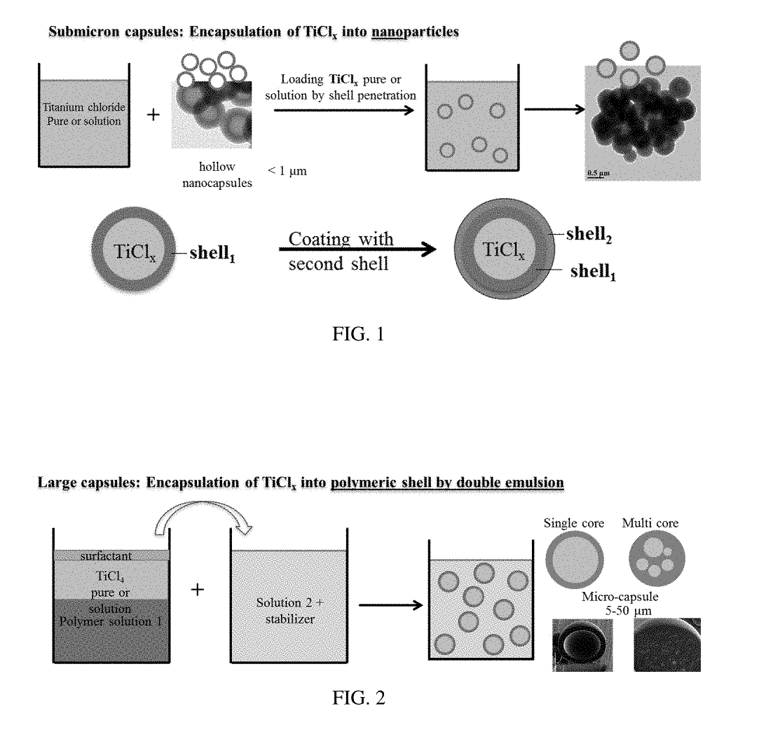

In accordance with embodiments of the present disclosure, two synthetic methodologies have been developed for preparation of sub-micrometer and micrometer-sized capsules. Referring to FIG. 1, a first methodology (herein also referred to as “Methodology 1”) is based on loading of TiClₓ into hollow polymeric nano- and/or micro-capsules, which produces titanium chloride capsules of <1 micron, or even <500 nm, in diameter. In accordance with embodiments of the present disclosure, fabricated polymeric nano- or micro-capsules (e.g., from polystyrene) may be added to a volume of pure titanium chloride, or a corresponding solution of TiClₓ, (or vice versa in that pure titanium chloride, or a corresponding solution, may be added to a volume of fabricated polymeric nano- and/or micro-capsules), and then the resulting mixture may be subjected to one or more successive vacuum/fill cycles with an inert gas to diffuse the pure titanium chloride, or corresponding solution, through the shell to fill the cavities of the capsules in order to encapsulate the TiClₓ in the polymeric shell.

As further depicted by the schematic diagrams in FIG. 1, embodiments of the present disclosure may add a second shell (e.g., with a layer-by-layer technique) on the TiClₓ capsules for decreasing the rate of acid generation from outside of the capsules. In accordance with embodiments of the present disclosure, such a second shell (denoted as “shell₂” in FIG. 1) may be added to the encapsulated titanium chloride to decrease the diffusion rate of compound and acid generation. This second shell may be created by adding encapsulated titanium chloride (i.e., encapsulated by the first shell₁) to a polymer solution (e.g., acrylonitrile/vinylidene chloride copolymer) containing a surfactant with simultaneous mixing followed by adding the resulting mixture to an aqueous phase (which can contain a polymer and/or surfactant) with simultaneous mixing.

Referring to FIG. 2, a second methodology (herein also referred to as “Methodology 2”) is based on encapsulation of titanium chloride through a double emulsion process, which can produce titanium chloride capsules of >1 micron, or even 5-50 microns in diameter. In accordance with embodiments of the present disclosure, pure titanium chloride, or a corresponding solution of TiClₓ, may be mixed with a surfactant and an organic polymeric solution, and the corresponding emulsion subsequently may be added to a second solution containing a well-known stabilizer. The resulting capsules (which may have a single core or multiple cores containing the encapsulated TiClₓ) can be used as is, or a second shell can be added to provide some further control (e.g., retardation) of the acid generation rate. This second shell may be created by mixing the encapsulated titanium chloride with a polymer solution (e.g., a acrylonitrile/vinylidene chloride copolymer) containing a surfactant followed by adding the resulting mixture to an aqueous phase (which can contain a polymer and/or surfactant) and performing further mixing.

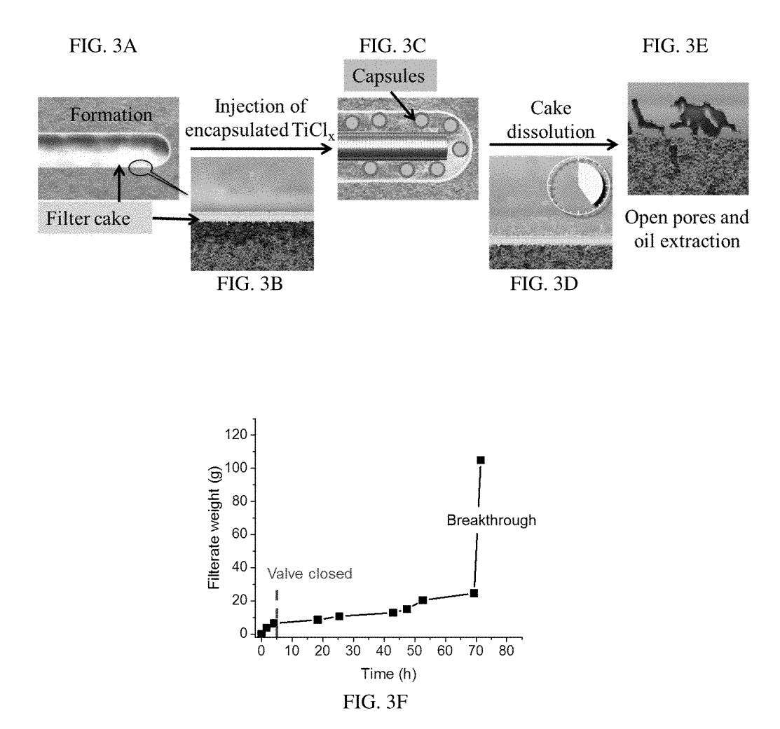

The polymeric shell of the capsule may be configured to inhibit (e.g., retard) an instantaneous reaction of the titanium chloride with water. For example, the polymeric shell may be configured to be either soluble and/or swellable under certain specified subterranean reservoir conditions, and thus be able to only deliver the generated acid to the porous media of a subterranean formation (e.g., an oil/gas reservoir) in an on-demand manner (i.e., upon its dissolution/swelling (e.g., see FIGS. 3A-3E)). For example, the polymeric shell may be configured to only dissolve and/or swell (and subsequently burst open) when the capsules are exposed to a specified condition (e.g., a certain range of temperatures, salinity, pressure, and/or water content) at the desired subterranean location. The dissolution and/or swelling rates may be controlled by the shell thickness, which can depend upon the utilized concentration of the polymer solution during formation of the capsules.

The overall sizes of the capsules may depend upon the utilized synthesis procedure, the amounts of encapsulated titanium chloride components, and the type of polymeric shell. For example, to increase the duration of (i.e., retard) release of the generated acid, the shell thickness may be increased (e.g., using Methodology 2), resulting in a corresponding decrease of core-to-shell mass ratio (i.e., lower loading efficiency of the titanium chloride).

Experiments

Embodiments of the present disclosure are further illustrated by the following examples, which are set forth to illustrate the presently disclosed subject matter and are not to be construed as limiting. The examples describe testing carried out to confirm the ability of embodiments of the present systems to deliver and release one or more materials under various conditions that exemplify various environments in which embodiments of the present disclosure may be utilized.

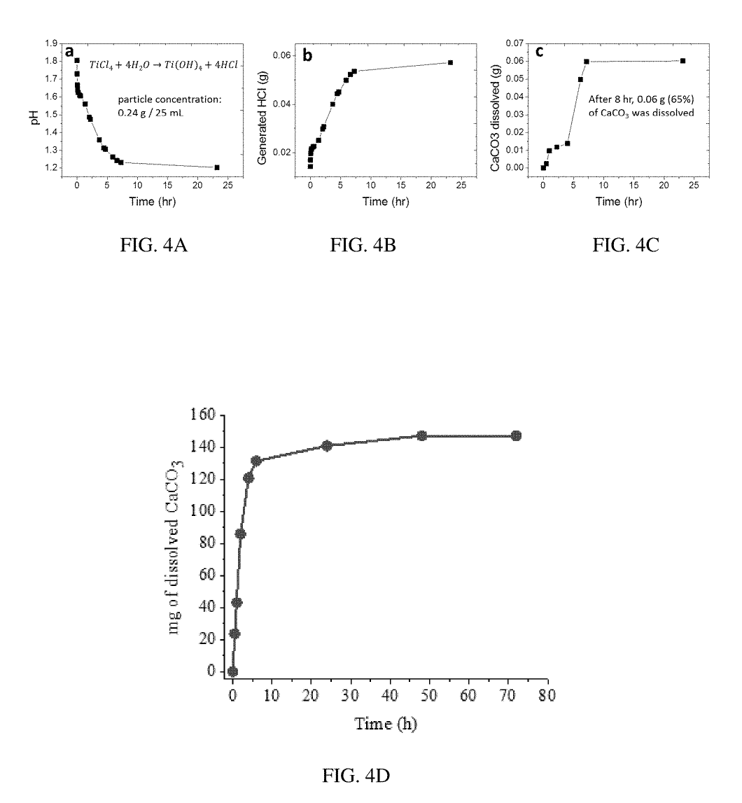

Referring again to FIG. 1, using Methodology 1 in accordance with certain embodiments of the present disclosure, poly(maleic anhydride-c-divinylbenzene) capsules loaded with TiCl₄ were prepared. The resulting titanium tetrachloride loaded capsules had an average radius of approximately 200 nm. These capsules were then dispersed in pure water, which permeated through the shell(s) of the capsules and initiated the HCl production (see Equation (1)). This acid release from the capsules into the surrounding water was monitored by measuring the pH of the volume containing the water and capsules. As shown in the graph in FIG. 4A, the pH decreased over an extended period of time (e.g., approximately 10 hours), which indicated that a delayed release (e.g., retarded) performance of the HCL from the capsules was achieved, which may be desired in many practical applications, such as discussed herein. The graph in FIG. 4B shows the absolute amount of acid (Generated HCL) released into the water during this reaction.

The graph in FIG. 4C shows that this released acid was sufficient to dissolve 60 mg of CaCO₃ dispersed in 25 mL of water. This CaCO₃ dissolution was used as a model experiment for filter cake and/or scale removal.

In another experiment, about 200 mg of capsules with encapsulated TiCl₄ were dispersed in brine to dissolve CaCO₃ particles at about 60° C. This particular sample produced about 53.3 wt. % of pure HCl (about 106.6 mg), which was sufficient to dissolve about 140 mg of solid CaCO₃. FIG. 4D illustrates a graph showing the CaCO₃ dissolution as a measure of the produced HCl.

The experiments associated with FIGS. 4C and 4D demonstrate how embodiments of the present disclosure (i.e., encapsulated titanium chloride) can be configured to dissolve filter cake and/or scale at subterranean locations (e.g., a wellbore or rock formation). Such applications are further described with respect to FIGS. 3A-3F.

Referring to FIGS. 3A-3E, capsules configured in accordance with embodiments of the present disclosure (i.e., encapsulated TiClₓ) can be produced (e.g., see Methodology 2) with diameters greater than one micron (e.g., about 1-50 microns), which can be used for cleaning of scale in a borehole casing, remediation to remove filter cake in the wellbore, and/or formation damage treatments. Smaller capsules (e.g., <1 micron, or even <500 nm, in diameter) configured in accordance with embodiments of the present disclosure can be produced (e.g., see Methodology 1) for enhanced oil/gas recovery (e.g., by providing fresh micro-channels (e.g., in which filter cake and/or scale has been removed) in the rock formation when injected therein.

FIG. 3A shows an exemplary rock formation in which filter cake (and/or scale) has formed (e.g., within a formation pore). FIG. 3B shows a magnified view of a portion of FIG. 3A, highlighting the layer of filter cake (and/or scale) deposited on a wall of the pore. FIG. 3C shows delivery of capsules configured in accordance with embodiments of the present disclosure into the formation. FIG. 3D shows dissolution of the filter cake over time due to release of the acid by the capsules (e.g., see FIGS. 4C and 4D). FIG. 3E shows the resultant opening of pores in the formation due to the dissolution of the filter scale thereby enhancing the extraction of hydrocarbons from the formation, which had been previously trapped by the filter cake.

FIG. 3F illustrates a graph of filtrate weight discharge versus time demonstrating, in accordance with embodiments of the present disclosure, an ability of a small amount of TiCl₄ loaded within capsules to result in a delayed breakthrough from filter cake clogging a wellbore. In the experiment from which this graph originated, about 1.85 grams of capsules each containing TiCl₄ within a shell were added to a 175 mL cell (i.e., a cylinder which had a preformed filter cake) with about 120 mL of brine. The cell (not shown) used for this experiment was made of an acid resistant material, rested in a heating jacket to control its temperature, and had a valve at the bottom to discharge the fluid. Its internal pressure was controlled by applying pressure to the top and/or bottom via an attached gas cylinder. A valve of the cell was then closed, and the experiment was conducted at about 60° C. and about 100 pounds per square inch of pressure to simulate typical conditions that can exist within a subterranean location, such as a wellbore or rock formation.

FIG. 5 illustrates an exemplary schematic of a system configured for delivering capsules 20 as described herein to a subterranean location, such as any desired portion of the wellbore and/or into the subterranean formation 30, through an injection well 10 via one or more injection ports 11, 12 (e.g., by utilizing well-known pumping equipment (not shown) to deliver a fluid containing the capsules). Hydrocarbons 18 (e.g., oil and/or natural gas) may be located in the formation 30, such as at multiple oil-water interfaces 32. A recovery well 14 may also be utilized for recovery (e.g., by utilizing well-known pumping equipment (not shown)) of the capsules 20 from the formation 30 (or, the capsules may be recovered via the well 10).

As described herein, after delivery of the capsules 20 to the subterranean location, the capsules will interact with water/brine contained within the environment of the subterranean location (e.g., by the permeation of the water/brine through the shell(s) of the capsules), which will result in the in situ generation of the acid within the capsules 20 (e.g., see Equation (1)). Note that the capsules (and any vehicle (e.g., fluid) in which they are delivered to the subterranean location) may be configured so that there is not generation of acid within the capsules 20 until after they have been delivered to the desired subterranean location. At some time after the acid begins to be generated within the capsules, the shell(s) of the capsules 20 will release the generated acid (e.g., as a result of the degradation of the shell(s) by the generated acid, or the utilization of a polymer material for the shell that permits a diffusion of the acid through the shell). Furthermore, the titanium hydroxide byproduct can also assist in the dispersion of the capsules in a brine solution, which can facilitate removal of the capsules after acid production at the subterranean location (e.g., during recovery of the capsules as previously discussed via either the injection well 10 or the recovery well 14).

In accordance with certain aspects of the disclosure, any well-known polymer may be utilized for the shell material of the capsules disclosed herein in which the polymer material is configured to enable the diffusion of water molecules through the shell and into an interior of the capsule, including, but not limited to, polymer materials previously disclosed herein. Other possible polymer materials may include, but are not limited to, any well-known water-soluble polymer.

In accordance with certain aspects of the disclosure, the capsules may be of any shape or size, and if more than one capsule is present, the capsules may be of substantially the same shape and/or size, and/or different shapes and/or sizes, depending on the application. The capsules may be substantially spherical, or non-spherical in some cases. Those of ordinary skill in the art will be able to determine the average cross-sectional diameter of a single capsule and/or a plurality of capsules, for example, using laser light scattering, microscopic examination, or other known techniques. The average cross-sectional diameter of a non-spherical capsule is the diameter of a perfect sphere having the same volume as the non-spherical capsule. In some embodiments, at least about 50%, at least about 75%, at least about 90%, at least about 95%, or at least about 99% of the capsules within a plurality of capsules have an average cross-sectional diameter within any of the ranges outlined herein. Thus, the plurality of capsules may have relatively uniform cross-sectional diameters in accordance with certain embodiments.

In some embodiments of the disclosure, the plurality of capsules has an overall average diameter and a distribution of diameters such that no more than about 5%, no more than about 2%, or no more than about 1% of the capsules have a diameter less than about 90% (or less than about 95%, or less than about 99%) and/or greater than about 110% (or greater than about 105%, or greater than about 101%) of the overall average diameter of the plurality of capsules (such as described herein with respect to Methodology 1 or Methodology 2). In certain embodiments of the disclosure, the plurality of capsules has an overall average diameter and a distribution of diameters such that the coefficient of variation of the cross-sectional diameters of the capsules is less than about 10%, less than about 5%, less than about 2%, between about 1% and about 10%, between about 1% and about 5%, or between about 1% and about 2%. The coefficient of variation (cᵥ) can be determined by those of ordinary skill in the art, and may be defined as:

$${c}_{v} = \frac{σ}{\vert μ \vert}$$

where σ (sigma) is the standard deviation and μ (mu) is the mean.

In addition, in certain embodiments of the disclosure, the capsules may be of substantially the same shape and/or size (i.e., “monodisperse”), or of different shapes and/or sizes, depending on the particular application or the method of synthesis utilized. In certain embodiments of the disclosure, the capsules may have a homogenous distribution of cross-sectional diameters, i.e., the capsules may have a distribution of cross-sectional diameters such that no more than about 10%, about 5%, about 3%, about 1%, about 0.03%, or about 0.01% of the capsules have an average diameter that is more than about 10%, about 5%, about 3%, about 1%, about 0.03%, or about 0.01% different from the average cross-sectional diameter of the capsules.

In certain embodiments of the disclosure, the shell, or shells, of a capsule has an average thickness (averaged over the entire capsule) of less than about 0.05, less than about 0.01, less than about 0.005, or less than about 0.001 times the average cross-sectional diameter of the capsule, or between about 0.0005 and about 0.05, between about 0.0005 and about 0.01, between about 0.0005 and about 0.005, or between about 0.0005 and about 0.001 times the average cross-sectional diameter of the capsule. In certain embodiments of the disclosure, at least about 50%, at least about 75%, at least about 90%, at least about 95%, or at least about 99% of the capsules within a plurality of capsules includes a shell, or shells, having an average thickness within any of the ranges outlined herein. One of ordinary skill in the art would be capable of determining the average thickness of a shell by, for example, examining scanning electron microscope (“SEM”) images of the capsules.

In certain embodiments of the disclosure, other species may be present within the capsules, e.g., in one or more regions, portions, or sections within the capsule. For instance, in various embodiments, the capsules can include a determinable species, for example, quantum dots or fluorescent molecules, which can be used to identify (e.g., locations in the formation) capsules. As a non-limiting example, a plurality of capsules may be exposed to different environments or conditions, and the capsules can be readily determined or distinguished, for instance, using the determinable species. Quantum dots or fluorescent molecules can be readily obtained commercially.

In certain embodiments of the disclosure, the capsules may include magnetically susceptible species. The species may be used, for example, to allow magnetic separation of the capsules. Thus, for example, a magnetic field may be used to separate the magnetically-susceptible capsules from other, non-magnetically-susceptible capsules, from a liquid solution, or the like. Non-limiting examples of magnetically susceptible species include iron oxide, magnetite, hematite, other compounds containing iron, or the like. In certain embodiments of the disclosure, the magnetically susceptible species is present as one or more nanoparticles.

In accordance with certain embodiments of the present disclosure, the capsules may be suspended in any vehicle suitable for delivery of the capsules to a desired subterranean location, including a vehicle that does not enable interaction between a material encapsulated within the capsules (e.g., titanium chloride) and the vehicle. In certain embodiments, the vehicle in which the capsules are suspended can be hydrophilic.

Examples of suitable hydrophilic vehicles include, but are not limited to, alcohols (e.g., butanol (e.g., n-butanol), isopropanol (“IPA”), propanol (e.g., n-propanol), ethanol, methanol, glycerin, or the like), acids (e.g., formic acid, acetic acid, or the like), amines (e.g., dimethyl amine, diethyl amine, or the like), mixtures of these, and/or other similar fluids. In certain embodiments, polar protic solvents (e.g., alcohols, acids, bases, etc.) can be used in the hydrophilic vehicle. In certain embodiments, polar aprotic solvents can be used in the hydrophilic vehicle, including, for example, dimethyl sulfoxide (“DMSO”), acetonitrile (MeCN), dimethylformamide (“DMF”), acetone, or the like. It should be understood that embodiments of the disclosure are not limited to hydrophilic vehicles, and, in other embodiments, hydrophobic vehicles could be used.

In certain embodiments of the present disclosure, the capsules may be exposed to any location believed to contain hydrocarbons (whether it is subterranean or not). The oil that the capsules may be exposed to is not limited herein to only crude oil, but also may include, in certain embodiments, any other types of oils or hydrocarbons. Various non-limiting examples of oils are discussed herein.

In certain embodiments, the capsules may be delivered or injected (e.g., see FIG. 5) into a subterranean oil reservoir, which may include, for example, deep wells, rocks, soil, shale, etc. However, it should be noted that embodiments of the present disclosure are not limited to delivery of capsules to crude oil contained in the ground, e.g., within a subterranean oil reservoir. In certain embodiments, capsules can be delivered to any suitable hydrocarbons or oil, including crude oil, petroleum, or natural gas, whether within the ground or not in the ground, synthetic, or natural, purified or unpurified, refined or unrefined, treated or untreated, etc.

As used herein, “oil” is used to refer to petroleum and all other hydrocarbons, regardless of molecular weight or composition, produced from a well in the ground (e.g., a subterranean formation). Typically, the crude oil is a liquid, although in some cases, the crude oil may also be recovered as a solid or a semi-solid (e.g., a sludge). The systems, articles, techniques, and methods described herein may be used, in some cases, to sense or uptake any type of crude oil, as is discussed herein. As non-limiting examples, the crude oil may include “heavy” crude oil (American Petroleum Institute gravity (“API gravity”) of 20 degrees or less), “intermediate” crude oil (API gravity of between 20 degrees and 40.1 degrees), and/or “light” crude oil (API gravity of 40.1 degrees or greater). API gravity is, generally, a measure of density, and those of ordinary skill in the art will be able to determine the API gravity of a sample of crude oil. As another example, the systems, techniques, methods, and articles described herein may be configured to deliver a vehicle containing the capsules to sweet crude oil (i.e., oil containing less than 0.5 wt % sulfur) and/or sour crude oil (i.e., oil containing 0.5 wt % or more of sulfur).

It is contemplated that any embodiment discussed in this specification can be implemented with respect to any method, kit, reagent, or composition of the disclosure, and vice versa. Furthermore, compositions of the disclosure can be used to achieve methods of the disclosure.

It will be understood that particular embodiments described herein are shown by way of illustration and not as limitations of the disclosure. Principal features of this disclosure can be employed in various embodiments without departing from the scope of the disclosure.

While the compositions, systems, and methods of this disclosure have been described in terms of described embodiments, it will be apparent to those of skill in the art that variations may be applied to the compositions, systems, and/or methods and in the steps or in the sequence of steps of the methods described herein without departing from the concept, spirit, and scope of the disclosure. All such similar substitutes and modifications apparent to those skilled in the art are deemed to be within the spirit, scope, and concept of the disclosure as defined by the appended claims.

Unless defined otherwise, all technical and scientific terms used herein have the same meaning as commonly understood to one of ordinary skill in the art to which the presently disclosed subject matter belongs. Although any systems, methods, techniques, articles, devices, and materials similar or equivalent to those described herein can be used in the practice or testing of the presently disclosed subject matter, representative systems, methods, technique articles, devices, and materials have been described herein.

The terms “a” and “an” mean “one or more” when used in this application, including the claims.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in this specification and attached claims are approximations that can vary depending upon the desired properties sought to be obtained by the presently disclosed subject matter.

As used herein, the terms “about” or “approximately” when referring to a value or to an amount of mass, diameter, weight, time, volume, concentration, or percentage is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method.

As used herein, “significance” or “significant” relates to a statistical analysis of the probability that there is a non-random association between two or more entities. To determine whether or not a relationship is “significant” or has “significance,” statistical manipulations of the data can be performed to calculate a probability, expressed as a “p value.” Those p values that fall below a user-defined cutoff point are regarded as significant. In some embodiments, a p value less than or equal to 0.05, in some embodiments less than 0.01, in some embodiments less than 0.005, and in some embodiments less than 0.001, are regarded as significant. Accordingly, a p value greater than or equal to 0.05 is considered not significant.

As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a defacto equivalent of any other member of the same list solely based on their presentation in a common group without indications to the contrary.

Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of approximately 1 to approximately 4.5 should be interpreted to include not only the explicitly recited limits of 1 to approximately 4.5, but also to include individual numerals such as 2, 3, 4, and sub-ranges such as 1 to 3, 2 to 4, etc. The same principle applies to ranges reciting only one numerical value, such as “less than approximately 4.5,” which should be interpreted to include all of the above-recited values and ranges. Further, such an interpretation should apply regardless of the breadth of the range or the characteristic being described.

Any steps recited in any method or process disclosed herein may be executed in any order and are not limited to the order presented. Means-plus-function or step-plus function limitations will only be employed where for a specific claim limitation all of the following conditions are present in that limitation: a) “means for” or “step for” is expressly recited; and b) a corresponding function is expressly recited. The structure, material, or acts that support the means-plus function are expressly recited in the description herein. Accordingly, the scope of the disclosure should be determined solely by the appended claims and their legal equivalents, rather than by the descriptions and examples given herein.

1. A system comprising equipment configured to deliver a capsule to a subterranean location, wherein the capsule is configured to only generate an acid in situ after delivery to the subterranean location.

2. The system as recited in claim 1, wherein the subterranean location contains water molecules, and wherein the capsule has a shell configured to enable interaction of the water molecules with a material contained within the capsule.

3. The system as recited in claim 2, wherein the material is titanium chloride, which produces the acid when the titanium chloride interacts with the water molecules, wherein the acid is hydrochloric acid.

4. The system as recited in claim 3, wherein the shell is configured to only enable the interaction of the water molecules with the material contained within the capsule by diffusion of the water molecules through the shell to an interior of the capsule where the titanium chloride is located.

5. The system as recited in claim 4, wherein titanium hydroxide is generated by the interaction of the titanium chloride with the water molecules.

6. The system as recited in claim 2, wherein the shell of the capsule is configured to release the acid to dissolve filter cake or scale deposited on a surface at the subterranean location.

7. The system as recited in claim 4, wherein the subterranean location is a subterranean rock formation.

8. The system as recited in claim 4, wherein the subterranean location is a wellbore.

9. The system as recited in claim 4, further comprising equipment configured to recover the capsule from the subterranean location back to a surface location.

10. A method comprising:
delivering a capsule to a subterranean location, wherein the capsule has a shell encapsulating a material within an interior of the capsule;
the shell configured to enable the material to interact with a medium located outside of the capsule only after delivery of the capsule to the subterranean location;
in situ generation of an acid from the interaction of the material with the medium; and
the capsule releasing the acid into an environment at the subterranean location.

11. The method as recited in claim 10, wherein the medium contains water molecules, and wherein the material is titanium chloride, wherein the acid is generated within an interior of the capsule when the titanium chloride interacts with the water molecules after the water molecules have diffused through the shell to the interior of the capsule.

12. The method as recited in claim 11, wherein the acid is hydrochloric acid.

13. The method as recited in claim 12, further comprising degradation of a portion of the shell by the hydrochloric acid resulting in a release of the hydrochloric acid from the interior of the capsule into the environment at the subterranean location.

14. The method as recited in claim 13, further comprising the hydrochloric acid dissolving filter cake deposited on a surface at the subterranean location.

15. The method as recited in claim 13, further comprising the hydrochloric acid dissolving scale deposited on a surface at the subterranean location.

16. The method as recited in claim 10, wherein the subterranean location is a subterranean rock formation.

17. The method as recited in claim 10, wherein the subterranean location is a wellbore.

18. The method as recited in claim 10, recovering the capsule from the subterranean location back to a surface location.

19. The method as recited in claim 12, wherein a concentration of the hydrochloric acid generated within the capsule is greater than a 37 wt % hydrochloric acid solution.

20. The method as recited in claim 13, further comprising:
generating titanium hydroxide by the interaction of the titanium chloride with the water molecules; and
retarding the release of the hydrochloric acid from the interior of the capsule into the environment at the subterranean location by a presence of the titanium hydroxide within the capsule.
